(19) United States
(12) Patent Application Publication
(10) Pub. No.: US 2008/0073106 A1
(43) Pub. Date: Mar. 27, 2008

(54) Twisted pairs cable having shielding layer and dual jacket

(75) Inventors: Doug Brake, Denver, NC (US); Trent Hayes, Hickory, NC (US)

Correspondence Address: MG-IP Law, PLLC, P.O. BOX 1364, FAIRFAX, VA, 22038-1364, US

(73) Assignee: CommScope Solutions Properties LLC

(21) Appl. No.: 11/525,918

(22) Filed: Sep. 25, 2006

(51) Int. Cl. H01B 11/02

(52) U.S. Cl. 174/113 R

(57) ABSTRACT

A cable includes a plurality of twisted wire pairs housed inside an inner jacket, a shielding layer, and an outer jacket. Each of the twisted wire pairs has a respective twist length, defined as a distance wherein the wires of the twisted wire pair twist about each other one complete revolution. At least two of the respective twist lengths purposefully vary along a length of the cable. In one embodiment, the cable includes four twisted wire pairs, each with its twist length purposefully varying along the length of the cable. The twisted wire pairs may have a pair separator located there between. The pair separator may also twist, and may twist in a direction opposite to a twist direction of the twisted wire pairs. The cable is designed to surpass the requirements of CAT 6 and CAT 6A cabling, and demonstrates no alien crosstalk and low internal crosstalk characteristics even at data bit rates of 10 Gbit/sec and beyond.

### BACKGROUND OF THE INVENTION

1. Field of the Invention

The present invention relates to a cable employing a plurality of twisted wire pairs. More particularly, the present invention relates to a twisting scheme for the twisted wire pairs in combination with a jacketing construction for housing the plurality of twisted wire pairs, which reduces or eliminates the likelihood of transmission errors because of internal or alien crosstalk, eliminates interference from adjacent cables and electrical fields, and reduces signal attenuation, and hence allows for a relatively higher bit rate transmission.

2. Description of the Related Art

Along with the greatly increased use of computers for homes and offices, there has developed a need for a cable, which may be used to connect peripheral equipment to computers and to connect plural computers and peripheral equipment into a common network. Today's computers and peripherals operate at ever increasing data transmission rates. Therefore, there is a continuing need to develop a cable, which can operate substantially error-free at higher bit rates, but also satisfy numerous elevated operational performance criteria, such as a reduction in internal and alien crosstalk when the cable is in a high cable density application. e.g. routed alongside other cables.

U.S. Pat. No. 5,952,607, which is incorporated herein by reference, discloses a typical twisting scheme employed in common twisted pair cables. FIG. 1 shows four pairs of wires (a first pair A, a second pair B, a third pair C and a fourth pair D) housed inside of a common jacket, constituting a first common cable E. In FIG. 1, the jacket has been partially removed at the end of the cable and the wire pairs A, B, C, D have been separated, so that the twist scheme can be clearly seen. FIG. 1 also illustrates a second common cable J, which is separate from the first common cable E, but identical in construction to the first common cable E. The second common cable J also includes four pairs of wires (a fifth pair F, a sixth pair G, a seventh pair H and an eight pair I) housed inside of a common jacket.

Each of the wire pairs A, B, C, D has a fixed twist interval a, b, c, d, respectively. Since the first and second common cables E and J are identical in construction, each of the wire pairs F, G, H, I also has the same fixed twist interval a, b, c, d, respectively. Each of the twist intervals a, b, c, d is different from the twist interval of the other wire pairs. As is known in the art, such an arrangement assists in reducing crosstalk between the wire pairs within the first common cable E. Further, as is common in the art, each of the twisted wire pairs has a unique fixed twist interval of slightly more than, or less than, 0.500 inches. Table 1 below summarizes the twist interval ranges for the first through eight pairs A, B, C, D, F, G, H, I.

TABLE 1

| | | Min. Twist | Max. Twist |
|---|---|---|---|
| Pair No. | Twist Length | Length | Length |
| A/F | 0.440 | 0.430 | 0.450 |
| B/G | 0.410 | 0.400 | 0.420 |
| C/H | 0.596 | 0.580 | 0.610 |
| D/I | 0.670 | 0.650 | 0.690 |

Cable with the twisting scheme outlined above, such as the cable disclosed in U.S. Pat. No. 5,952,607, have enjoyed success in the industry. However, with the ever-increasing demand for faster data rate transmission speeds, it has become apparent, that the cable of the background art suffers drawbacks. Namely, the background art's cable exhibits unacceptable levels of Alien near end crosstalk (ANEXT), at higher data transmission rates.

A step toward improving the cable can be seen in U.S. Pat. No. 6,875,928, which is incorporated herein by reference. U.S. Pat. No. 6,875,928 appreciated that side-by-side cables having twisted pairs with identical respective twist lengths presented a crosstalk problem and disclosed a cable wherein each of the twisted wire pairs has a twist length which purposefully varies, e.g. modulates, along a length of the cable. Also, the twisted wire pairs may have a core strand length, defined as a distance wherein the twisted wire pairs twist about each other one complete revolution, and the core strand length may purposefully vary along the length of the cable.

The cable having modulated twist lengths of U.S. Pat. No. 6,875,928 has enjoyed commercial success and demonstrated improvements in alien crosstalk performance over the cable shown in U.S. Pat. No. 5,952,607. However, with data bit rates ever increasing, there is a need in the art to eliminate alien crosstalk and to improve on the internal, as opposed to alien, crosstalk performance of cable.

### SUMMARY OF THE INVENTION

It is an object of the present invention to provide a cable with improved internal and/or alien crosstalk performance, as compared to existing cable.

It is a further object of the present invention to combine a variation or modulation in twist length for wire pairs in a cable with a dual jacket and shielding layer to synergistically reduce the internal crosstalk levels of the cable, and eliminate the alien crosstalk levels of the cable.

It is a still further object of the present invention to incorporate a pair separator into the cable having the modulated twisted wire pairs in combination with the dual jacket and shielding layer design.

It is a yet further object of the present invention to twist the pair separator in the cable having the modulated twisted wire pairs in combination with the dual jacket and shielding layer design.

It is also an object of the present invention to provide a cable which is easy and inexpensive to manufacture, simple to install, demonstrates low alien and internal crosstalk characteristics even at data bit rates of 10 Gbit/sec and beyond, and which surpasses the standards set for CAT 6A cables.

These and other objects are accomplished by a cable that includes a plurality of twisted wire pairs housed inside a first jacket, a shielding layer, and an outside, second jacket. Each of the twisted wire pairs has a respective twist length, defined as a distance wherein the wires of the twisted wire pair twist about each other one complete revolution. At least two of the respective twist lengths purposefully vary along a length of the cable. In one embodiment, the cable includes four twisted wire pairs, with each twisted wire pair having its twist length purposefully varying along the length of the cable. The twisted wire pairs may have a pair separator located there between. The pair separator may also twist, and a twist direction of the pair separator may be opposite to the twist direction of the twisted wire pairs.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a perspective view of two ends of two identical but separate cables having a jacket removed to show four twisted wire pairs, in accordance with the background art;

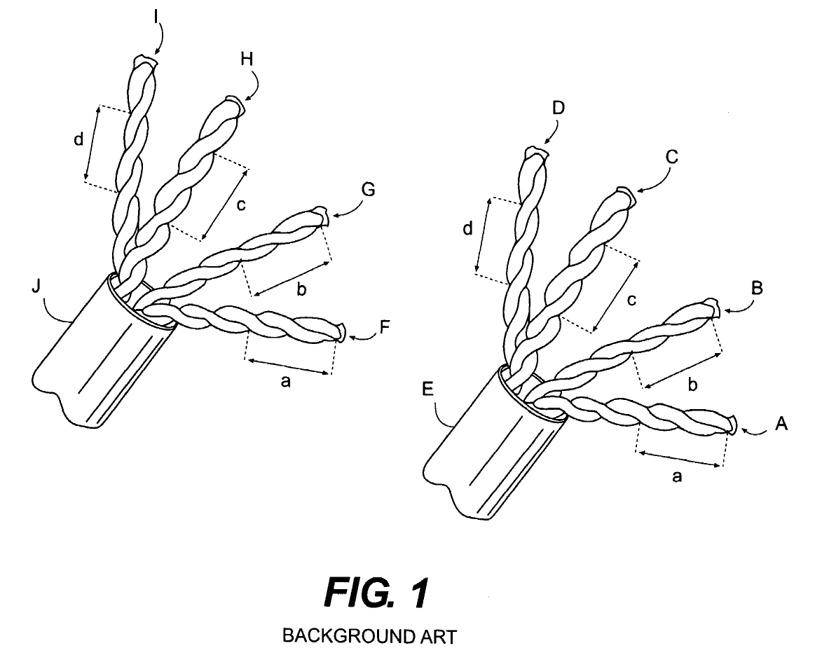

FIG. 2 is a perspective view of an end of a cable having first and second jackets and a shielding layer partially removed to show four twisted wire pairs, in accordance with the present invention;

FIG. 3 is a perspective view similar to FIG. 2, but with a greater portion of the jackets and shielding layer removed and the twisted pairs separated to show a twisting scheme, in accordance with the present invention;

FIG. 4 is a cross sectional view taken along line IV-IV of FIG. 3;

FIG. 5 is a perspective view of an end of a modified cable having the first and second jackets and a modified shielding layer partially removed to show four twisted wire pairs, in accordance with a second embodiment of the present invention;

FIG. 6 is a graph demonstrating the internal NEXT performance of the first twisted wire pair of the cable of FIGS. 2-4;

FIG. 7 is a graph demonstrating the internal NEXT performance of the second twisted wire pair of the cable of FIGS. 2-4;

FIG. 8 is a graph demonstrating the internal NEXT performance of the third twisted wire pair of the cable of FIGS. 2-4; and

FIG. 9 is a graph demonstrating the internal NEXT performance of the fourth twisted wire pair of the cable of FIGS. 2-4.

### DETAILED DESCRIPTION OF A PREFERRED EMBODIMENT

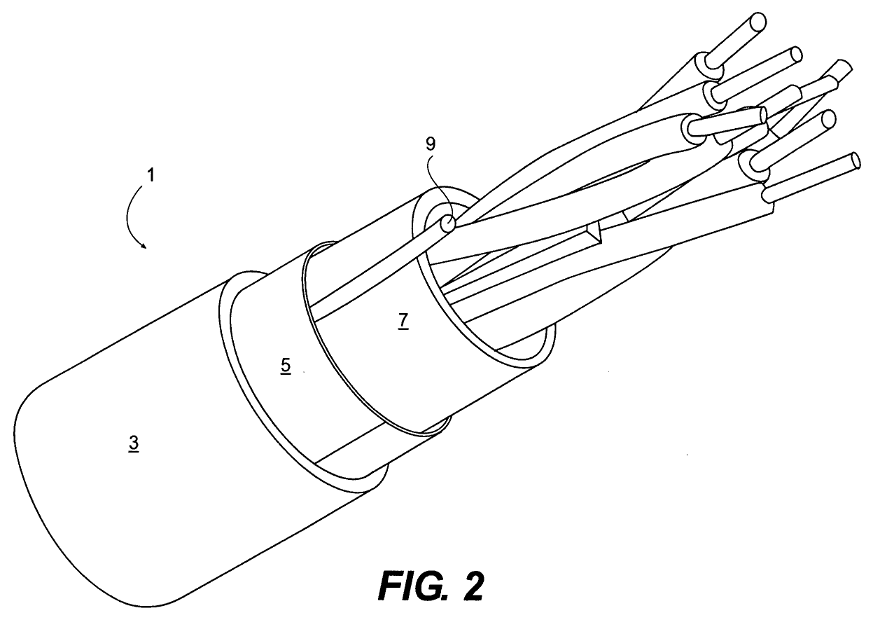

FIG. 2 illustrates an end of a cable, in accordance with the present invention. The end of the cable 1 has an outer, first jacket 3 partially removed. The first jacket 3 may be formed of any nonconductive material, however polyvinylchloride (PVC), flame retardant polyvinylchloride (FR-PVC), and polyvinylchloride fluoride (PVDF) are particularly advantageous in forming the first jacket 3. In a preferred embodiment, the first jacket 3 has a radial thickness of about 20 mils, such as a thickness selected between 17 mils and 25 mils, e.g. 23 mils. However, other thicknesses are within the scope of the present invention. The diameter of the outer surface of the first jacket 3, and hence the diameter of the overall cable 1, is about 0.3 to 0.4 inches, and more preferably about 0.315 to 0.325 inches.

Beneath the first jacket 3 resides a shielding layer 5. The shielding layer 5 is also partially removed in FIG. 2. The shielding layer 5 may be made of any conductive material, and may take the form of a foil or a braid. FIG. 2 illustrates the shielding layer 5 in the form of a foil. The foil may be advantageously made of aluminum and bonded to polypropylene, a polyester tape or MYLAR for stability and uniform coverage. In a preferred embodiment, the shielding layer has a radial thickness of about 4 mils, such as a thickness selected between 3 mils and 5 mils, e.g. 3.5 mils. However, other thicknesses are within the scope of the present invention. In a preferred embodiment, the shielding layer 5 is formed of a conductive foil facing away from the first jacket 3 and a MYLAR backing facing toward the first jacket 3.

Beneath the shielding layer 5 resides an inner, second jacket 7. The second jacket 7 is also partially removed in FIG. 2. The second jacket 7 may be formed of any nonconductive material, however PVC, FR-PVC, and PVDF are particularly advantageous in forming the second jacket 3. In a preferred embodiment, the second jacket 7 has a radial thickness which is less than a radial thickness of the first jacket 3. For example, the second jacket 7 could have a radial thickness of about 18 mils, such as a thickness selected between 15 mils and 25 mils. However, other thicknesses are within the scope of the present invention.

As can be seen in FIG. 2, a drain wire 9 is provided between the shielding layer 5 and the second jacket 7. The drain wire 9 is used for grounding purposes when the cable 1 is terminated at a printed wiring board (PWB) or connector (e.g. a plug or a jack). The drain wire 9 is formed of a conductive material, like steel, copper or tinned copper and provides an easily accessible means of grounding instead of, or in addition to, a grounding electrical connection formed with the shielding layer 5 at the termination end of the cable 1. In one embodiment, the drain wire 9 is solid and has a diameter of about 20 mils. However, the diameter of the drain wire may be varied and the materials used to form the drain wire may also be varied. For example, the drain wire 9 could be a stranded wire of about 24 gauge.

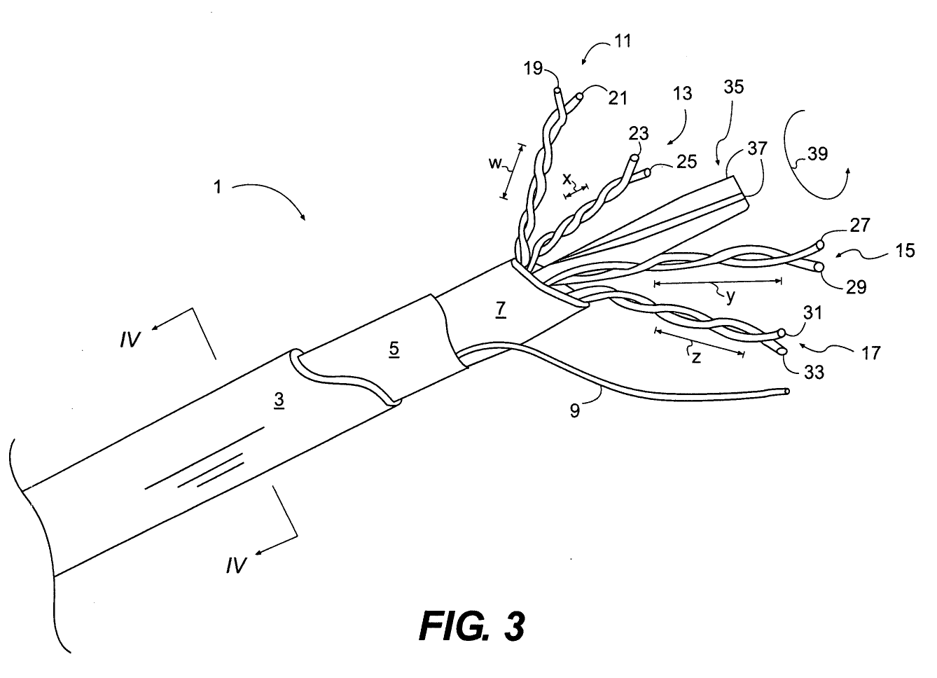

FIG. 2 illustrates a plurality of twisted wire pairs housed within the second jacket 7. FIG. 3 is a perspective view similar to FIG. 2, but with a greater portion of the first and second jackets 3, 7 and shielding layer 5 removed and the twisted wire pairs separated to show a twisting scheme, in accordance with the present invention. As illustrated in FIG. 3, the cable 1 has a first twisted wire pair 11, a second twisted wire pair 13, a third twisted wire pair 15, and a fourth twisted wire pair 17. Each twisted wire pair includes two conductors. Specifically, the first twisted wire pair 11 includes a first conductor 19 and a second conductor 21. The second twisted wire pair 13 includes a third conductor 23 and a fourth conductor 25. The third twisted wire pair 15 includes a fifth conductor 27 and a sixth conductor 29. The fourth twisted wire pair 17 includes a seventh conductor 31 and an eighth conductor 33.

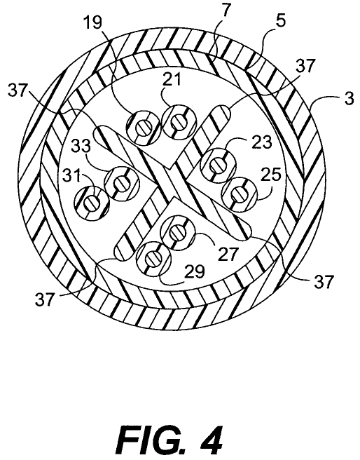

Each of the first through eighth conductors 19, 21, 23, 25, 27, 29, 31, 33 is constructed of an insulation layer surrounding an inner conductor, as best seen in FIG. 4. The outer insulation layer may be formed of a flexible plastic material having flame retardant and smoke suppressing properties. The inner conductor may be formed of a metal, such as copper, aluminum, or alloys thereof. It should be appreciated that the insulation layer and inner conductor may be formed of other suitable materials.

As illustrated in FIG. 3, each twisted wire pair 11, 13, 15, 17 is formed by having its two conductors continuously twisted around each other. For the first twisted wire pair 11, the first conductor 19 and the second conductor 21 twist completely about each other, three hundred sixty degrees, at a first interval w along the length of the cable 1. The first interval w purposefully varies along the length of the cable 1. For example, the first interval w could purposefully vary randomly within a first range of values along the length of the cable 1. Alternatively, the first interval w could purposefully vary in accordance with an algorithm along the length of the cable 1.

For the second twisted wire pair 13, the third conductor 23 and the fourth conductor 25 twist completely about each other, three hundred sixty degrees, at a second interval x along the length of the cable 1. The second interval x purposefully varies along the length of the cable 1. For example, the second interval x could purposefully vary randomly within a second range of values along the length of the cable 1. Alternatively, the second interval x could purposefully vary in accordance with an algorithm along the length of the cable 1.

For the third twisted wire pair 15, the fifth conductor 27 and the sixth conductor 29 twist completely about each other, three hundred sixty degrees, at a third interval y along the length of the cable 1. The third interval y purposefully varies along the length of the cable 1. For example, the third interval y could purposefully vary randomly within a third range of values along the length of the cable 1. Alternatively, the third interval y could purposefully vary in accordance with an algorithm along the length of the cable 1.

For the fourth twisted wire pair 17, the seventh conductor 31 and the eighth conductor 33 twist completely about each other, three hundred sixty degrees, at a fourth interval z along the length of the cable 1. The fourth interval z purposefully varies along the length of the cable 1. For example, the fourth interval z could purposefully vary randomly within a fourth range of values along the length of the cable 1. Alternatively, the fourth interval z could purposefully vary in accordance with an algorithm along the length of the cable 1.

Each of the twisted wire pairs 11, 13, 15, 17 has a respective first, second, third and fourth mean value within the respective first, second, third and fourth ranges of values. In one embodiment, each of the first, second, third and fourth mean values of the intervals of twist w, x, y, z is unique. For example, in one of many embodiments, the first mean value of the first interval of twist w is about 0.336 inches; the second mean value of second interval of twist x is about 0.315 inches; the third mean value of the third interval of twist y is about 0.628 inches; and the fourth mean value of the fourth interval of twist z is about 0.537 inches.

The first, second, third and fourth ranges of values for the first, second, third and fourth intervals of twist w, x, y, z should vary more than ±0.01 inches from the mean value for the respective range. For example, Table 2 shows one embodiment where the first, second, third and fourth ranges of values for the first, second, third and fourth intervals of twist w, x, y, z varying by ±0.05 inches from the mean value for the respective range.

TABLE 2

| Twisted Wire | Mean Twist | Min. Twist | Max. Twist |
|---|---|---|---|
| Pair | Length | Length | Length |
| First | 0.336 | 0.286 | 0.386 |
| Second | 0.315 | 0.265 | 0.365 |
| Third | 0.628 | 0.578 | 0.678 |
| Fourth | 0.537 | 0.487 | 0.587 |

In another embodiment, the first, second, third and fourth ranges of values for the first, second, third and fourth intervals of twist w, x, y, z extend up to ±0.02 inches from the mean value for the respective range, as summarized in Table 3 below:

TABLE 3

| Twisted Wire | Mean Twist | Min. Twist | Max. Twist |
|---|---|---|---|
| Pair | Length | Length | Length |
| First | 0.336 | 0.316 | 0.356 |
| Second | 0.315 | 0.295 | 0.335 |
| Third | 0.628 | 0.608 | 0.648 |
| Fourth | 0.537 | 0.517 | 0.557 |

By purposefully varying the intervals of twist w, x, y, z along the length of the cable 1, it is possible to reduce internal near end crosstalk (NEXT) to an acceptable level, even at high speed data bit transfer rates over the cable 1. Alien near end crosstalk (ANEXT) is nonexistent due to the shielding layer 5.

FIG. 3 also illustrates a pair separator 35. The pair separator 35 is a cross-shaped member, as best seen in the cross sectional view of FIG. 4, which is taken across line IV-IV in FIG. 3. The pair separator may be formed of any nonconductive material, however FR polyolefin, natural polyolefin or a fluoropolymer are particularly advantageous in forming the pair separator 35. In a preferred embodiment, the pair separator 35 has four equal size wings 37, each with a thickness of about 22 mils, such as a thickness selected between 20 mils and 25 mils. However, other thicknesses are within the scope of the present invention.

The pair separator 35 serves to separate the twisted wire pairs 11, 13, 15, 17 in the cable 1, each from the others. As illustrated in FIG. 3, the pair separator 35 twists in a first direction, indicated by arrow 39. The twist direction of the pair separator 35 is preferably opposite to the twist directions of the first, second, third and fourth twisted wire pairs 11, 13, 15, 17. For example, in the cable 1 of FIG. 3, the pair separator 35 twists to the right, whereas each of the pairs 11, 13, 15, 17 twists to the left. In a preferred embodiment, the pair separator 35, and hence the core, has a fixed twist length in the range of 2.5 to 6 inches, more preferably a twist length of about 4 inches.

Twisting the pair separator 35 in an opposite direction, as compared to the twist direction of the twisted pairs 11, 13, 15, 17 is advantageous. In fact, the arrangement saves materials, reduces the weight and rigidity of the cable 1 and reduces the overall cost to produce the cable 1 per unit length. If the pair separator 35 is twisted in a same direction as the twisted wire pairs 11, 13, 15, 17 during the cable fabrication, the twists in the pairs 11, 13, 15, 17 actually tighten up. Tightening the twists in the twisted wire pairs 11, 13, 15, 17 shortens the twisted wire pairs 11, 13, 15, 17. Hence, more wire is employed per unit length of the cable 1, which increases the weight, rigidity and cost per unit length of the cable 1. By twisting the pair separator 35 in the opposite direction, the twists in the twisted wire pairs 11, 13, 15, 17 slightly loosen during the cable fabrication process. This reduces the weight, rigidity and cost per unit length of cable 1.

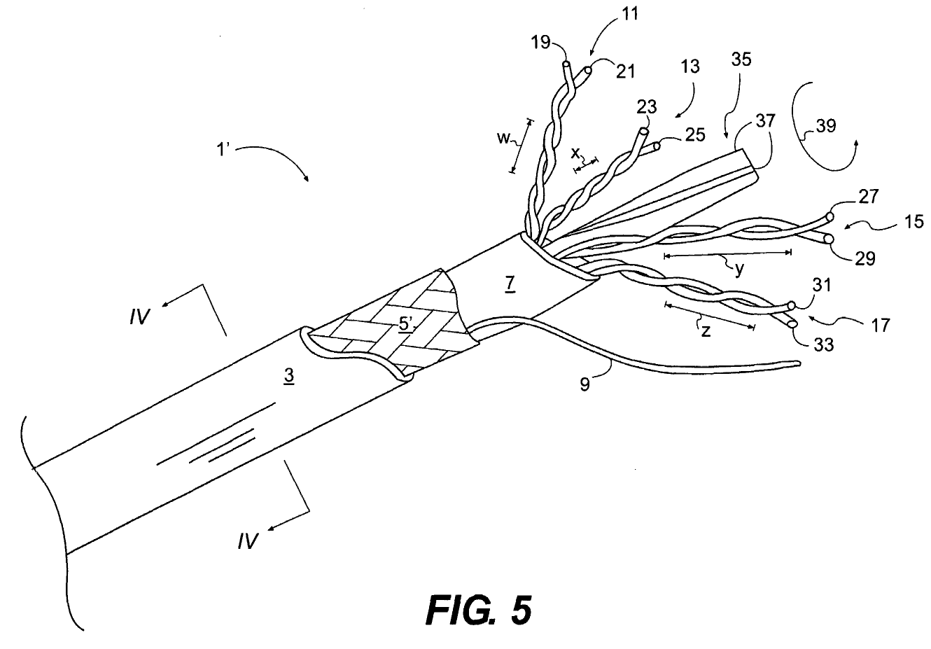

Although FIGS. 3 and 4 illustrates the pair separator 35 as a solid plastic-like material, the pair separator 35 could also be a foam separator. Also, although FIG. 3 illustrates a foil shielding layer, a braided shielding layer could be used. For example, FIG. 5 illustrates a cable 1′, which is identical to the cable 1 of FIG. 3, except for the employment of a braided shielding layer 5′. The braided shielding layer 5′ could be formed of braided flexible wires, such as aluminum, copper, tinned copper, for similar metals.

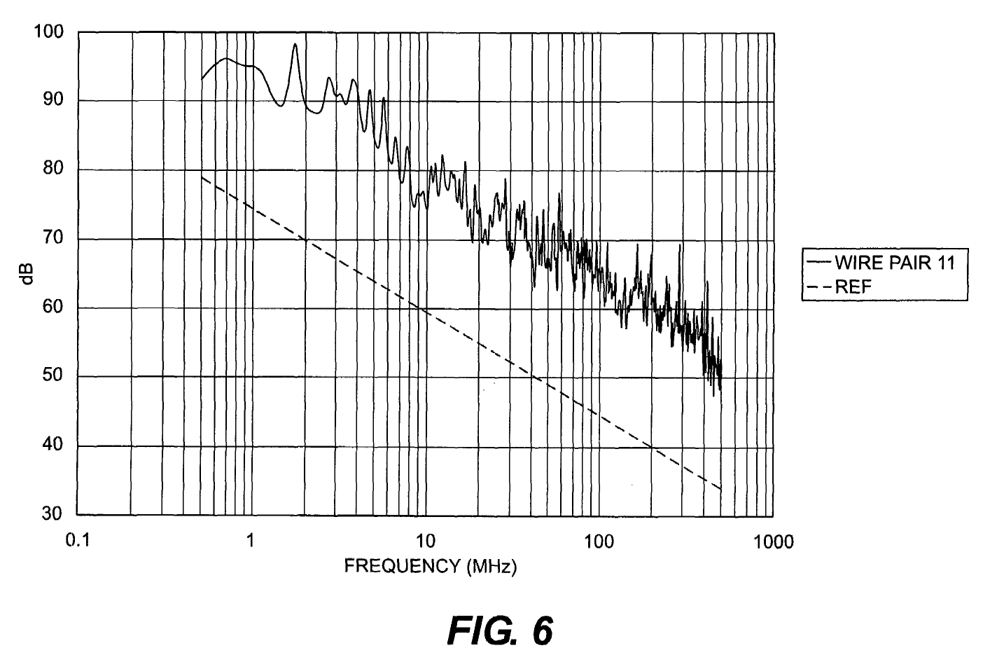

FIG. 6 illustrates the internal NEXT for the first twisted wire pair 11 of the cable 1 constructed in accordance with FIGS. 2-4 and having the variable intervals of twist w, x, y, z residing within the ranges outlined in Table 2, above. To obtain the data of FIG. 6, the input of a vector network analyzer (VNA) is connected to the first twisted wire pair 11 of the cable 1 while the output of the VNA is connected to the second twisted wire pair 13. The VNA is used to sweep over a band of frequencies from 0.5 MHz to 500 MHz and the ratio of the signal strength detected on first twisted wire pair 11 over the signal strength applied to second twisted wire pair 13 is captured. This is the internal NEXT contributed to the first twisted wire pair 11 from the second twisted wire pair 13. Contributions to the first twisted wire pair 11 from the third and fourth twisted wire pairs 15 and 17 are acquired in the same manner. The power sum of contributions from the second, third and fourth twisted wire pairs 13, 15 and 17 to the first twisted wire pair 11 is the internal NEXT of the first twisted wire pair 11 and is represented as trace T1 in FIG. 6 on a logarithmic scale.

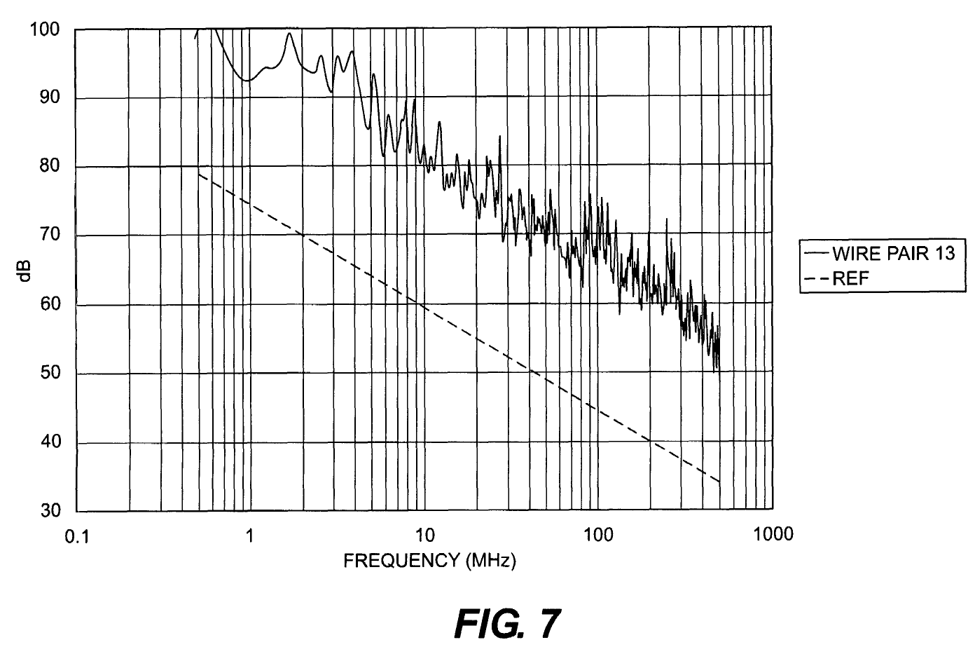

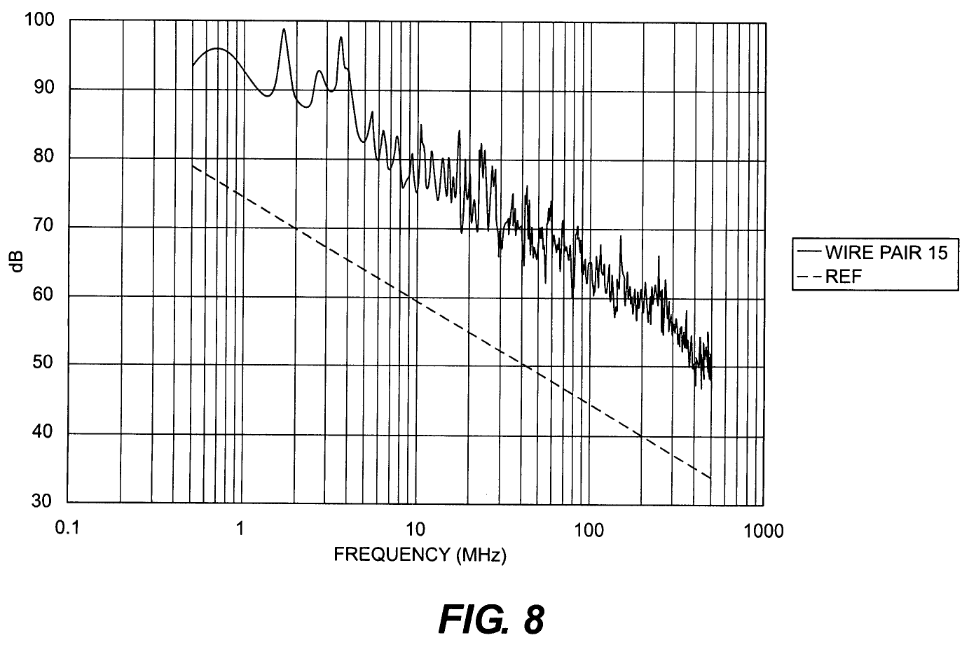

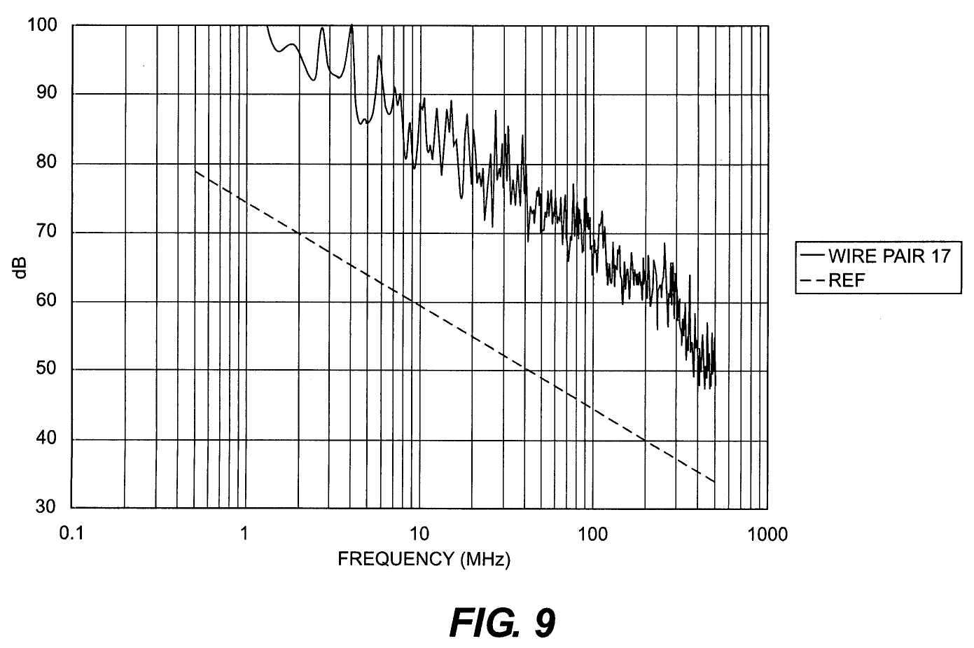

The above procedure is repeated for the second, third and fourth twisted wire pairs 13, 15 and 17 of the cable 1. The graph of FIG. 7 illustrates the internal NEXT T2 for the second twisted wire pair 13 as caused by the first, third and fourth twisted wire pairs 11, 15, 17. The graph of FIG. 8 illustrates the internal NEXT T3 for the third twisted wire pair 15 as caused by the first, second and fourth twisted wire pairs 11, 13, 17. The graph of FIG. 9 illustrates the internal NEXT T4 for the fourth twisted wire pair 17, as caused by the first, second and third twisted wire pairs 11, 13, 15.

The graphs of FIGS. 6-9 illustrate the internal NEXT T1, T2, T3, T4 for frequencies between 0.5 MHz to 500 MHz for the first second, third and fourth twisted wire pairs 11, 13, 15, 17. A reference line REF described by the function 44.3-15*log(f/100) dB, where f is in the units of MHz is included in FIGS. 6-9 and serves as a reference above which potentially acceptable internal NEXT performance is achieved. As can be seen in the graphs, acceptable cable performance can be achieved at frequencies of 650 MHz and higher across the cable, in accordance with the present invention, which surpasses CAT 6A standards.

Now, certain advantages of the cable 1, in accordance with the present invention, will be described in detail. Previous cable designs with twisted wire pairs were known whereby a shielding layer could be employed inside of a jacket. It was known that such a shielding layer would eliminate the concerns of alien crosstalk, i.e. cable-to-cable crosstalk. Such a cabling design functioned adequately until data transmission speeds were increased.

At higher data transmission speeds, the shielding layer being adjacent to the twisted wire pairs caused excessive internal crosstalk. Therefore, cable designs turned away from the shielding layer and went to other designs to prevent alien crosstalk, such as twisting wire pairs more tightly. Another alien NEXT solution for cables without shielding layers was to twist each pair at a unique fixed twist rate, and finally to modulate the twist rate for each pair about a different mean value.

In the present invention, Applicants were able to bring back the shielding layer to completely eliminate alien crosstalk. To deal with the internal crosstalk issues generated by a shielding layer, the present invention employs the synergistic benefits of an inner dielectric jacket to distance to the twisted pairs from the shielding layer in combination with a modulation scheme for the twisted wire pair. A third contribution to the combination to assist in reducing internal NEXT is the employment of the pair separator 35. This synergistic combination allows the elimination of alien NEXT, while controlling internal NEXT to a level acceptable for CAT 6A cabling.

The present invention has shown at least one set of ranges for the values of the variable twist intervals w, x, y, z, which greatly improves the internal NEXT performance, while maintaining the cable within the specifications of standardized cables and enabling an overall cost-effective production of the cable. In the embodiment set forth above, the twist length of each of four pairs is purposefully varied by more than ±0.01 inches from the respective twisted pair's twist length's mean value, such as by ±0.02 inches or ±0.03 inches. It should be appreciated that this is only one embodiment of the invention. It is within the purview of the present invention that more or less twisted wire pairs may be included in the cable 1 (such as two pair, twenty five pair, or one hundred pair type cables). Further, the mean values of the twist lengths of respective pairs may be set higher or lower. Even further, the purposeful variation in the twist length may be set higher or lower.

As disclosed above, a cable constructed in accordance with the present invention, shows a high level of immunity to internal NEXT and eliminates alien NEXT, which translates into a cable capable of faster data transmission rates and a reduced likelihood of data transmission errors. The invention being thus described, it will be obvious that the same may be varied in many ways. Such variations are not to be regarded as a departure from the spirit and scope of the invention, and all such modifications as would be obvious to one skilled in the art are to be included within the scope of the following claims.
a plurality of twisted wire pairs, each of said twisted wire pairs including two conductors each separately surrounded by an insulation and which along essentially the entire length of the cable are twisted about each other in accordance with a twist scheme, wherein:
   a first twisted wire pair of said plurality of twisted wire pairs has a twist length, defined as a length along said cable during which the two conductors of said first twisted wire pair twist completely about each other three hundred sixty degrees, which varies along the length of said cable about a first mean value; and
   a second twisted wire pair of said plurality of twisted wire pairs has a twist length, defined as a length along said cable during which the two conductors of said second twisted wire pair twist completely about each other three hundred sixty degrees, which varies along the length of said cable about a second mean value, wherein the first mean value is different than the second mean value;
a first jacket surrounding said plurality of twisted wire pairs;
a shielding layer surrounding said first jacket; and
a second jacket surrounding said shielding layer.

2. The cable of claim 1, wherein said plurality of twisted wire pairs includes a third twisted wire pair and a fourth twisted wire pair, and wherein:
said third twisted wire pair has a twist length, defined as a length along said cable during which the two conductors of said third twisted wire pair twist completely about each other, three hundred sixty degrees, which varies along the length of said cable about a third mean value; and
said fourth twisted wire pair has a twist length, defined as a length along said cable during which the two conductors of said fourth twisted wire pair twist completely about each other, three hundred sixty degrees, which varies along the length of said cable about a fourth mean value.

3. The cable of claim 2, further comprising:
a pair separator separating each of said first, second, third and fourth twisted wire pairs.

4. The cable of claim 3, wherein said pair separator twists along the length of said cable.

5. The cable of claim 4, wherein said pair separator has a twist length, defined as a length along said cable during which said pair separator twists completely around, three hundred sixty degrees, which is approximately 4 inches in length.

6. The cable of claim 1, further comprising:
a pair separator separating said first twisted wire pair from said second twisted wire pair.

7. The cable of claim 6, wherein said pair separator twists along said cable in a direction opposite to a twist direction of said first and second twisted wire pairs.

8. The cable of claim 1, wherein said shielding layer is formed of a conductive foil.

9. The cable of claim 1, wherein said shielding layer is formed of braided, conductive wires.

10. The cable of claim 1, further comprising:
a drain wire residing adjacent to said shielding layer and extending along the length of said cable.

11. The cable of claim 1, wherein a thickness of said first jacket is less than a thickness of said second jacket.

12. The cable of claim 1, wherein said first and second jackets are formed of a same material.

13. The cable of claim 12, wherein said first and second jackets are formed of polyvinylchloride (PVC), flame retardant polyvinylchloride (FR-PVC), or polyvinylchloride fluoride (PVDF).

14. A cable comprising:
a plurality of twisted wire pairs, each of said twisted wire pairs including two conductors each separately surrounded by an insulation and which along essentially the entire length of said cable are twisted together in accordance with a twist scheme including:
a first twisted wire pair having a twist length varying by at least ±0.01 inches about a first mean value along the length of the cable;
a second twisted wire pair having a twist length varying by at least ±0.01 inches about a second mean value along the length of the cable;
a third twisted wire pair having a twist length varying by at least ±0.01 inches about a third mean value along the length of the cable; and
a fourth twisted wire pair having a twist length varying by at least ±0.01 inches about a fourth mean value along the length of the cable, wherein the first mean value is different than the second mean value;
a first jacket surrounding said plurality of twisted wire pairs;
a shielding layer surrounding said first jacket; and
a second jacket surrounding said shielding layer.

15. The cable according to claim 14, wherein the first mean value is different than the third and fourth mean values, wherein the second mean value is different than the third and fourth mean values, and wherein the third mean value is different than the fourth mean value.

16. The cable according to claim 15, wherein the first mean value is approximately 0.628 inches, the second mean value is approximately 0.315 inches, the third mean value is approximately 0.537 inches, and the fourth mean value is approximately 0.336 inches.

17. The cable according to claim 16, wherein said first twisted wire pair has a twist length that varies within approximately ±0.05 inches from the first mean value, said second twisted wire pair has a twist length that varies within approximately ±0.05 inches from the second mean value, the third twisted wire pair has a twist length that varies within approximately ±0.05 inches from the third mean value, and the fourth twisted wire pair has a twist length that varies within approximately ±0.05 inches from the fourth mean value.

18. The cable according to claim 15, wherein said first twisted wire pair has a twist length that varies within approximately ±0.05 inches from the first mean value, said second twisted wire pair has a twist length that varies within approximately ±0.05 inches from the second mean value, the third twisted wire pair has a twist length that varies within approximately ±0.05 inches from the third mean value, and the fourth twisted wire pair has a twist length that varies within approximately ±0.05 inches from the fourth mean value.

19. The cable of claim 15, further comprising:
a pair separator separating each of said first, second, third and fourth twisted wire pairs.

20. The cable of claim 19, wherein said pair separator twists along the length of said cable.

21. The cable of claim 20, wherein said pair separator has a twist length, defined as a length along said cable during which said pair separator twists completely around three hundred sixty degrees, which is approximately 4 inches in length.

22. The cable of claim 20, wherein said pair separator twists along said cable in a direction opposite to a twist direction of said first, second, third and fourth twisted wire pairs.

23. The cable of claim 14, wherein a thickness of said first jacket is less than a thickness of said second jacket.

24. The cable of claim 14, wherein said first and second jackets are formed of a same material.

25. The cable of claim 8, further comprising: a backing layer bonded to said conductive foil.

26. The cable of claim 25, wherein said conductive foil faces away from said second jacket and said backing layer faces toward said second jacket.

27. The cable of claim 1, wherein a thickness of said first jacket is greater than a thickness of said shielding layer.
